(19) United States
(12) Patent Application Publication
(10) Pub. No.: US 2026/0060265 A1
(43) Pub. Date: Mar. 5, 2026

(54) POURABLE WATER-IN-OIL COOKING EMULSIONS

(71) Applicant: Flora Food Global Principal B.V., Amsterdam (NL)

(72) Inventors: Wai Seng WONG, Amsterdam (NL); Georg Christian DOL, Amsterdam (NL); Abraham LEENHOUTS, Amsterdam (NL); Andreas Julius VAN DEN BERG, Amsterdam (NL)

(73) Assignee: Flora Food Global Principal B.V., Amsterdam (NL)

(21) Appl. No.: 19/384,457

(22) Filed: Nov. 10, 2025

Related U.S. Application Data
(63) Continuation of application No. PCT/EP2024/063090, filed on May 13, 2024.

(30) Foreign Application Priority Data
May 11, 2023 (EP) 23172830.4

(51) Int. Cl. A23D 7/00; A23D 9/00

(52) U.S. Cl. CPC A23D 7/003; A23D 9/00

(57) ABSTRACT

Edible, pourable, fat-containing product, preferably in the form of a water-in-oil emulsion or a full fat product, comprising 40 to 99.9 wt. % liquid vegetable oil; 0.1 to 10 wt. % of hard stock fat; water up to 100 wt. %, wt. % calculated on the total weight of the product, wherein the hard stock fat is free from palm or palm-derived fats or fat fractions; free from hydrogenated fats or fat fractions and has a C22:0 (behenic acid) content of at least 10 wt. %, wt. % calculated on the amount of fatty acids in the hard stock.

### CROSS-REFERENCE TO RELATED APPLICATIONS

This application is a continuation of PCT/EP2024/063090 filed May 13, 2024, which claims priority to European Patent Application No. 23172830.4 filed May 11, 2023, the entire contents of each of which is hereby incorporated by reference in their entirety.

### FIELD OF THE DISCLOSURE

The present disclosure is directed to edible pourable fat-containing compositions. The disclosure is further directed for a method for making such compositions and to their use.

### BACKGROUND OF THE DISCLOSURE

Food compositions suitable for shallow frying are well-known. Examples of such food compositions are butter, (liquid) margarine, and cooking milk.

In particular pourable water-in-oil cooking compositions are well appreciated by consumers as easily dosed and perceived to be more healthy than solid or plastic water-in-oil products such as butter or wrapper margarines. Furthermore pourable water-in-oil products are fatty to the touch, which is perceived as more suitable for shallow frying than for example cooking milk which are oil-in-water systems (having a continuous water-phase). Water-in-oil emulsions are characterized by having a continuous fat-phase and a dispersed water-phase, generally in the form of water droplets. The pourability of such compositions is typically evidenced by a Bostwick value of at least 6 at 20 degrees Celsius.

Margarine typically has a continuous fat phase and an aqueous phase which is dispersed as fine droplets in the fat phase.

In contrast to common margarine which has a semi-solid, plastic, spreadable consistency, liquid margarine is pourable at ambient temperature.

All margarine fats consist of a mixture of a fat which at ambient temperature is fully liquid (an oil), and a fat which is solid at ambient temperature, the so-called hard stock fat which has stabilizing or structuring functionality, sometime also indicated as structuring fat. The ratio of liquid and solid fat is chosen such that after proper processing together with an aqueous phase a product with a suitable plastic consistency is obtained. In common margarine the crystals of the solid fat form a network throughout the liquid oil resulting into a structured fat phase. The aqueous phase droplets are fixed within the spaces of the lattice of solid fat crystals. In this way coalescence of the droplets and separation of the heavier aqueous phase from the fat phase is prevented. Wrapper margarines need more solid fat than tub margarines and tub margarines need more than liquid margarines. Moreover, liquid margarines need a different kind of stabilising fat.

The presence of hard stock fat aims to stabilise the margarine emulsion. Unstable liquid margarines show phase separation. Phase separation, particularly oil exudation, becomes visible as a layer of oil on the surface of the liquid margarine.

The general process for the manufacture of pourable water-in-oil cooking compositions encompasses the following steps:
1. Providing a water-phase;
2. Providing a fat-phase;
3. Mixing to provide a water-in-oil emulsion.

These steps are usually conducted in a process that involves apparatus that allow heating (e.g. to dissolve emulsifiers and any other ingredients), cooling and mechanical working of the ingredients.

Pourable water-in-oil cooking compositions suitable for frying typically have a relatively large fat-phase to allow suitable frying of food products. For frying food products, the consumer typically places food product in the pan comprising heated frying medium at a temperature above 100 degrees Celsius, such as 160-170 degrees Celsius (i.e. above the typical boiling point of water at ambient conditions). At such conditions any water quickly evaporates typically under formation of some foaming, leaving the fat-phase. Once any water present is boiled-off (e.g. also as initially present in the emulsion), the foam typically also disappears rather quickly (if any was formed at all). Consumers consider it desirable that foam develops during the boiling-off of water-phase during the initial heating of the frying medium, but also when later a water-containing food-product is placed in the heated frying medium. Typically when later a water-containing food product is placed in the heated frying medium again some foaming may occur. The formation of foam, which also remains visible for some time after formation (i.e. which does not quickly disappear again) is perceived as healthy, since it imparts an aerated nature to the frying medium during heating and the frying of water-containing food products. There also pourable products known that do not contain water (full fat products) and can be used for the same purpose.

Typically, the fat-phase of a pourable composition comprises a liquid oil and a hard stock. The hard stock fat, or structuring fat provides stability to the emulsion. In the art, the hard stock fat used is typically capable of providing solid fat crystals. However, fat crystals also adversely affect the pourability of the resulting product. Developing hard stock fats that are suitable for pouring emulsions that are capable of combining stability and pourability is hence a problem in the art. The manufacture of pourable frying products therefore requires a hard stock fat with properties which are delicately balanced.

US2004/071857 describes a hard stock fat used for a liquid margarin as an alternative for fully hydrogenated high erucic acid rapeseed oil that is a non-hydrogenated fat that contains relative high amount of saturated long chain fatty acids. The hard stock fats are non-hydrogenated, and made by interesterification of fraction of high palmitic fats such as derived from palm oil and high stearic fats such as shea and others, optionally followed by fractionation.

WO200105241 describes the use of hydrogenated triglycerides in an attempt to find a replacement for fully hydrogenated high erucic acid rapeseed oil (RPhe70 or RPh70). One reasons for the desire for a replacement is the high price of RPhe70. To that end, SF69 (fully hydrogenated sunflower oil. RP68 (fully hydrogenated rape seed oil), BO65 (fully hydrogenated bean oil), PO58 (fully hydrogenated palm oil) are investigated alone or in (interesterified) blends. The use of fully hydrogenated high erucic acid rape seed oil as a structuring fat is believed to reside in the presence of a significant fraction of triacylglycerides consisting of fatty acids with a chain length difference of 4 carbon atoms. It is believed that this feature causes crystal growth resulting in smaller platelet like crystals than for other common fully hydrogenated oils, e.g., SF69 (fully hydrogenated sunflower oil, RP68 (fully hydrogenated rape seed oil) of, BO65 fully hydrogenated bean oil, PO58 (fully hydrogenated palm oil). It is also indicated in WO200105241 that the use of RPh70 due to incomplete hydrogenation brings about increased levels of erucic acid which is less desirable from a nutritional point of view. WO2016005231 describes the use of fully hydrogenated high erucic acid rapeseed oil, also known in the art as RP70 or heRP70 as a hard stock fat in the preparation of a pourable water-in-oil emulsion. The high relative high amount of erucic acid (C22:1) in the rapeseed oil provides an increased level of C22:0 (behenic acid) when the rape seed oil is fully hydrogenated.

The disadvantage of using fully hydrogenated oils as hard stock fat lies predominantly in the decreased consumer acceptance of products that have undergone chemical modification and mandatorily have to show this on the label. In the desire to come to clean label products to accommodate a more conscious consumer behavior and to enhance consumer acceptance, it is hence a goal of the disclosure to provide for a hard stock fat that has the desired delicate balance between stability and pourability. It is furthermore preferred that the product has a reduced content of hydrogenated fats and is preferably free of hydrogenated fats oils or fats.

The physical storage stability of pourable fat-containing products is an important characteristic. For example, pourable fat-containing compositions may show undesirable formation of an oil layer on top of the emulsion after storage at temperatures between 5 and 25 degrees Celsius. The formation of such an oil layer is referred to as oil separation or exudation and is typically measured in millimeters. The color of a food product used as a frying medium can be determined by eye or any other suitable method that is available. In view of increased awareness among some consumers regarding health and naturalness, consumers appreciate a frying medium which has an appreciable color (i.e. is not whitish in appearance as is the case for many refined oils and fats) in particular a gold-yellow color. For full fat products, the stability of the dispersion of salt in the product is a measure for the quality and acceptability of the product.

Additionally or alternatively, the pourable water-in-oil compositions should have a short ingredient list. Furthermore, additives other than oil, water and common flavors (e.g. salt) which are not perceived to contribute to the health of the consumer are less desirable. The presence of such additives can reduce the healthy-perception of the product and lead to reduced consumer acceptance. Indeed more preferably, the additives other than oil, water and flavors (e.g. salt) have an appreciable positive (perceived) influence on consumer health.

The prior art discloses products which fulfill part of these characteristics, however none of the products disclosed in the art relates to products which show all of these desired characteristics.

### SUMMARY OF THE DISCLOSURE

It was found that one or more of these objectives are achieved by an edible pourable fat-containing product in the form of a water-in-oil emulsion or a full fat product suitable for frying comprising:
40 to 99 wt. % liquid vegetable oil;
0.1 to 10 wt. % of hard stock fat;
all wt. % calculated on the total weight of the product.
characterised in that the hard stock fat is
   i. free from palm or palm-derived fats or fat fractions;
   ii. free from hydrogenated fats or fat fractions;
   iii. has a C22:0 (behenic acid) content of at least 10 wt. %, wt. % calculated on the amount of fatty acids in the hard stock.

The disclosure further relates to a process for the preparation of the product and to the use of a hard stock fat according to the disclosure free from hydrogenated and/or palm-derived triacylglycerides (less than 1 wt. % calculated on the hard stock fat) as a structuring fat for a pourable product.

### DETAILED DESCRIPTION

Weight percentage (wt. %) is based on the total weight of the product unless otherwise stated. It will be appreciated that the total weight amount of ingredients will not exceed 100 wt. % based on total weight of the product.

The terms ‘fat’ and ‘oil’ are used interchangeably. Where applicable the prefix ‘liquid’ or ‘solid’ is added to indicate if the fat or oil is liquid or solid at ambient temperature as understood by the person skilled in the art. Ambient temperature is considered to be a temperature of about 20 degrees Celsius. Hard stock fat refers to a fat that is solid at ambient temperature as understood by the person skilled in the art. The terms ‘hard stock fat’, ‘structuring fat’ or ‘hard stock’ are used interchangeably. The terms ‘liquid hard stock fat’ and ‘hard stock fat in liquid form’ are used interchangeably.

Fat as used in the present disclosure refers to edible triglyceride based fat as understood by the person skilled in the art. The terms ‘triacylglycerols’, TAGs′, and ‘triglycerides’ are used interchangeably: they refer to esters of glycerol and three fatty acids. The fatty acid (moieties) of the TAGs may vary in length. The length of a fatty acid is commonly indicated by their carbon number. The fatty acid (moieties) may be saturated, monounsaturated or polyunsaturated.

The pourable product of the invention is in a preferred embodiment a water in oil emulsion comprising:
1. 40 to 99 wt. % liquid vegetable oil;
2. 0.1 to 10 wt. % of hard stock fat;
3. water
4. all wt. % calculated on the total weight of the product,
5, wherein the hard stock fat is
   i. free from palm or palm-derived fats or fat fractions;
   ii. free from hydrogenated fats or fat fractions; and
has a C22:0 (behenic acid) content of at least 10 wt. %, wt. % calculated on the amount of fatty acids in the hard stock.

The pourable product of the invention is in another preferred embodiment a full fat product comprising a liquid vegetable oil, preferably 40 to 99.9 wt. %, and 0.1 to 10 wt. % of hard stock fat, all wt. % calculated on the total weight of the product,
1, wherein the hard stock fat is
   free from palm or palm-derived fats or fat fractions;
   free from hydrogenated fats or fat fractions; and
   has a C22:0 (behenic acid) content of at least 10 wt. %, wt. % calculated on the amount of fatty acids in the hard stock.

### Liquid Oil

The liquid oil according to the disclosure may be single oil or a mixture of different oils. Preferably at least 50 wt. % of the liquid oil, based on total amount of liquid oil, more preferably at least 70 wt. %, even more preferably at least 80 wt. % and still even more preferably essentially all the liquid oil is oil of vegetable origin. The liquid oil fraction preferably comprises unmodified (non-hydrogenated) vegetable oil such as soybean oil, sunflower oil, linseed oil, low erucic rapeseed oil (Canola), corn oil (maize oil), olive oil, algae oil and blends of vegetable oils. For the purpose of this disclosure, algae oil is considered vegetable (non-animal) oil.

Preferably the liquid oil according to the disclosure comprises less than 2 wt. %, more preferably less than 1.5 wt. %, even more preferably less than 1.0 wt. % and still even more preferably less than 0.5 wt. % of trans fatty acids based on the total weight of the liquid oil.

Preferably the product according to the disclosure comprises from 40 or 50 to 99 wt. %, more preferably from 60 to 89 wt. % and even and more preferably from 70 to 88 wt. % of liquid oil.

The fat fraction can also be characterized by a triacylglyceride or TAG profile. In the TAG profile and throughout this application, the following abbreviations are used:

| | |
|---|---|
| M | Medium chain fatty acid (C12-C14) |
| H | Saturated long chain fatty acid >=C16 |
| P | Palmitic acid C16:0 |
| S | Stearic acid, C18:0 |
| A | Arachidonic acid C20:0 |
| B | Behenic acid C22:0 |
| U | Unsaturated fatty acid |
| O | Oleic acid C18:1 |
| L | Linoleic acid/linolenic acid C18:2, C18:3 |
| St | Saturated fatty acid |
| StStSt | Trisaturated glyceride |
| StU2 | Monosaturated triglyceride |
| StUSt | Symmetrical saturated triglyceride |
| St2U | Disaturated triglyceride |
| HUH | Symmetrical long chain triglyceride |
| H2U | Disaturated long chain triglyceride |
| HU2 | Monosaturated long chain triglyceride |
| U3 | Unsaturated triglyceride |
| H3 | Long chain saturated fatty acid triglyceride |
| H2M | Mixed (2 long, 1 medium) chain fatty acid triglyceride |
| M3 | Medium chain fatty acid triglyceride |
| Sh | Short chain fatty acid (C4-C10) |
| X | Any fatty acid (H, U or Sh) |

In this specification all parts, proportions and percentages are by weight: the amount of fatty acids in an oil or fat is based on the total amount of fatty acids in the oil or fat and the amount of fat in the fat composition is based on the total weight of the fat composition, unless otherwise stated.

### Water

The product may comprise water. Preferably, the product comprises an amount of water to bring the total balance of ingredients (oil, fats, and others) up to 100 wt. %. If the product contains water, it is preferably in the form of a water-in oil-emulsion. Preferably the emulsion according to the disclosure comprises from 10 to 40 wt. %, and more preferably from 15 to 30 wt. % of water. Preferably the pH of the water-phase is 4.0 to 6.5, more preferably form 4.4 to 6.0, even more preferably from 4.5 to 5.5 and still even more preferably from 4.6 to 5.0. Such pH is obtainable for example by addition of an edible acid. Suitable acids include lactic acid, citric acid, hydrochloric acid. The preferred acid is citric acid.

The product may be devoid of a water phase and hence can be named as a full fat product instead of a water-in-oil emulsion. The stability of the product can be characterized by the same parameters: viscosity and exudation (or phase separation) of the liquid oil from the product and measured in millimetres.

### Hard Stock Fat

The pourable product according to the disclosure comprises hard stock fat. The presence of hard stock fat in the pourable product aims to contribute to stabilization of the product. Unstable pourable frying products show separation in the form of oil separation. The solid fat crystals which are needed to provide stability to the product, on the other hand may adversely affect its pourability (i.e. the product is too thick). The manufacture of pourable frying products therefore requires a hard stock fat with properties which are delicately balanced.

In particularly preferred embodiments of the disclosure, the hard stock fat is used in an amount of less than 2 wt. %, preferably less than 1.99, 1.98, 1.95, 1.90, 1.80, 1.75, 1.5 or even less than 1.2 wt. %.

The hard stock fat of the disclosure has increased structuring properties and can be used in lower amount than conventional hard stock fats such as based on hydrogenated fats such as hydrogenated high erucic acid rape seed oil. Reduction of the amount of hard stock allows the incorporation of more oil and/or oil components and hence allows an increase of (healthy) unsaturated fatty acids and a lowering of saturated fatty acids. Also from an economical point of view it is advantageous to formulate products with structuring fats that have an increased structuring capacity. The use of products having increased structuring properties is further advantageous for technical reasons as less production capacity is needed for the production of hard stock fats. This results in an improvement of the total product economics.

Being able to use a specifically developed hard stock fat in such low amounts is desirable. Not only from an economic point of view, but also as it increases the relative amount of oil that can be incorporated, thereby providing high level of unsaturated fatty acids, which is seen not only seen as healthy, but the increased level of oil (such as sunflower or rapeseed oil) also contributes to the product being more natural. A product that is more natural is higher appreciated by today's consumer.

The inventors found that triacylglycerides that combined behenic acid fatty residues and stearic fatty acids residues on the glycerol backbone (glycerolmonostearatedibchenate, SBB, CN62: glyceroldistearatemonobehenate, SSB, CN58) appears to provide improved structuring properties over single-type fatty acid triglyceride such as glyceroltristearate (GTS, SSS, CN54), glyceroltribehenate (GTB, BBB, CN66). In preferred embodiments, the hard stock fat contains between 20 and 65 wt. % of SBB+SSB. Preferably, the hard stock fat contains less than 40 wt. % of SSS and/or less than 40 wt. % of BBB as it was found that the structuring effect of glyceroltristearate alone or of glyceroltribehenate or of a blend thereof on the stability and viscosity of the product was less than the structuring effect of the S and B mixed triglycerides. Typically, the product was too viscous. Conventionally used RPhe, high erucic acid rapeseed, contains a relative low amount (1-2 wt %) of erucic acid on the 2-position of the glycerol backbone, compared to the 1 and 3 position. Hydrogenation of RPhe to RPhe70 leads to similar low level of behenic acid on the 2-position. The inventors did not simply mimic RPhe70 by avoiding hydrogenation, but rather created a novel fat with an advantageous fatty acid profile and fatty acid distribution. This fat has a higher level of B on the 2-position of the glycerol backbone compared to heRP70, aiding in improving stability and viscosity and/or allowing the fat to be used in lower amounts. Additionally, this leads to the use of lower amounts of saturated fatty acids in the resulting products, which is considered a health benefit.

In embodiments, the hard stock fat may contain a blend or an interesterified mixture of GTS and GTB.

The hard stock fat of the disclosure can also be provided by the glycerolysis (esterification, catalysed or uncatalysed) of a mixture of stearic acid and behenic acid in a desired ratio as indicated above to result in a triacylglyceride containing the fatty acids in the desired ratio.

The present inventors found that the common hard stock fat for pourable compositions (heRPh70, hydrogenated high erucic acid rapeseed oil) contains a high (around 50%) level of SBB, CN62, a triglyceride with two behenic acid residues on the glycerol backbone. heRPh70 can further be characterised as having a level of SSB (CN58) of around 9%. The fatty acids on the 2-position of the glycerol backbone are about 64% S and 27% B.

The hard stock of the disclosure, can be characterised over heRP70 by having an decreased level of SBB, CN62.

The hard stock of the disclosure, can be characterised over heRP70 by having an increased level of SSB, CN58.

The hard stock of the disclosure can further be characterised by the amount of S and/or B on the 2-position (2-C18:0, 2-C22:0).

In a preferred embodiment, the hard stock fat of the disclosure can be characterised by one or more of
2-C18:0 between 40 and 75 wt. %, wt. % calculated on the total amount of fatty acids on the 2-position of the glycerol backbone,
2-C22:0 between 15 and 50 wt. %, wt. % calculated on the total amount of fatty acids on the 2-position of the glycerol backbone,
SBB of below 45 wt. %, wt. % calculated on the total amount of triglycerides in the hard stock. (range)
SSB of more than 10 wt. %, wt. % calculated on the total amount of triglycerides in the hard stock. (range)
PBB of less than 10 wt. %, wt. % calculated on the total amount of triglycerides in the hard stock. (range)
SSS of more than 15 wt. %, wt. % calculated on the total amount of triglycerides in the hard stock. (range)

It is suited for the manufacture of satisfactory water-in-oil emulsions which combine good stability with good pourability.

The disclosure also relates to the use of a hard stock fat free from hydrogenated and/or palm-derived triacylglycerides as defined herein elsewhere as a structuring fat, preferably in pourable fat-containing products.

The use of the hard stock fat of the disclosure is preferably in an amount of less than 2, preferably 1.5 wt. %, wt. % calculated on the total weight of the product. In embodiments, the amount can be higher than 0.5 and/or lower than 2 wt. %, preferably higher than 0.75 and/or lower than 1.5 wt. % or even higher than 1.00 and/or lower than 1.25 wt. % The use of such low amounts of structuring fat allows to lower the amount of saturated fatty acids in the pourable product considerably in favour of the inclusion of higher levels of unsaturated vegetable oils which experience a higher degree of acceptance from the consumer.

### Water-In-Oil Promoting Emulsifier

Water-in-oil promoting emulsifiers are known in the art. Typically fat soluble emulsifiers are used to in the manufacture of water-in-oil emulsions, whereas water soluble emulsifiers are typically used to improve the stability of oil-in-water emulsions, such as dressings. The Hydrophilic-Lipophilic Balance (HLB) of an emulsifier is a measure of the degree to which it is hydrophilic or lipophilic. The HLB value is a parameter which is describing the solubility of the surfactant. The HLB value is a concept introduced by Griffin in 1950 as a measure of the hydrophilicity or lipophilicity of nonionic surfactants. It can be determined experimentally by the phenol titration method of Marszall: see “Parfumerie, Kosmetik”, Vol. 60, 1979, pp. 444-448; and Rompp, Chemistry Lexicon, 8th Edition 1983, p. 1750. An emulsifier having an HLB value of 8 or lower is usually classified as being a water-in-oil promoting emulsifier and as fat soluble. Emulsifiers with an HLB of more than 8 are usually considered oil-in-water promoting.

Preferably the pourable water-in-oil emulsion according to the disclosure comprises from 0.05 to 2 wt. %, more preferably from 0.1 to 1.5 wt. % and even more preferably from 0.15 to 1 wt. % of water-in-oil promoting emulsifier.

Well known examples of suitable emulsifiers include lecithin, mono- and/or diglycerides and citric acid esters.

### Monoglyceride and Diglycerides

Monoglycerides and diglycerides are molecules comprising a glycerol moiety esterified to a single, respectively two fatty acid residues. Generally mono-, and or diglycerides can be characterized by the tail-length and the degree of unsaturation of their fatty acid residue. The mono-, and or diglycerides according to the disclosure (if present) may be a single type or a mixture of different types of mono-, and or diglycerides. Mono-, and or diglycerides according to the disclosure are commercially available, for example under the trade name Dimodan HP (98 wt. % of saturated fatty acid residues; Supplier: Danisco), Dimodan RT (20 wt. % of saturated fatty acid residues; Supplier: Danisco) or Dimodan U/J (15 wt. % of saturated fatty acid residues; Supplier: Danisco).

Citric acid and a monoglyceride (monoester of glycerol and a fatty acid) or diglyceride (di-ester of glycerol and two fatty acids) can form an ester under certain reaction conditions. The resulting reaction product mainly comprises citric acid, wherein one carboxylic group is esterified with one of the free hydroxyl groups of the glycerol backbone of the mono- or diglyceride. Some di- or even tri-esterified citric acid may be present in the resulting reaction mixtures, depending on the specific reaction conditions used such as temperature and reaction time. According to a preferred aspect of the disclosure the ester (if present) is a citric acid ester of a monoglyceride and diglyceride mixture, comprising at least 30 wt. % of the monoglyceride, more preferred at least 55 wt. %, most preferred at least 90 wt. % of the monoglyceride. Citric acid esters are commercially available under the tradenames Grindsted™ CITREM LR 10, Grindsted™ CITREM BC-FS, Lamegin ZE 306, Myvatem SC, CITREM 2931, Palsgaard 3301, Lamegin ZE 309 liquid.

Lecithin is a collective name of products which consist of a few well-defined substances and many more or less well-defined substances in varying amounts. Common non-purified lecithin (crude lecithin) typically consists of about one half or more of phospholipids. Other substances present in crude lecithin are fats (typically about 35 wt. %), free fatty acids, glycolipids, tocopherols, sterols and carbohydrates. Most commercially available lecithins are prepared on the basis of soybeans, but lecithin is also found inter alia in animal sources, such as yolk and other vegetable sources, such as in rapeseed and sunflower oil. Preferably the lecithin according to the disclosure (if present) is derived from a vegetable source, more preferably soybeans, sunflower seeds or rapeseed or any a combination thereof, and even more preferably is derived from a combination of sunflower seeds and soybeans. Lecithin may be treated, such as by hydrogenation or hydrolysation, to alter the HLB-value. Suitable lecithin according to the disclosure is commercially available, for example under the trade name Cetinol (Supplier: Sime Darby, Unimills).

Preferably the water-in-oil promoting emulsifier according to the disclosure comprises lecithin, monoglyceride, diglyceride, citric acid ester or a combination thereof and more preferably comprises lecithin. Preferably the water-in-oil promoting emulsifier according to the disclosure has an HLB value of below 8, more preferably an HLB of 2 to 6 and even more preferably an HLB of 3 to 5.

### Process to Manufacture Water-In-Oil Emulsion

The water-in-oil emulsions according to the disclosure can be manufactured using well established methods as known in the art. The process may simply involve combining all ingredients and mixing under sufficient shear and for a sufficient period of time to homogenize the ingredients and provide a pourable water-in-oil emulsion.

In a preferred process, a water-phase and oil-phase are first (separately) prepared before being combined. Thus in a further aspect the present disclosure provides a process for the manufacture of the edible pourable water-in-oil emulsion according to the disclosure, comprising the steps:
a) providing a water-phase;
b) providing an oil-phase;
c) mixing the water-phase and the oil-phase to provide the edible pourable water-in-oil emulsion;
wherein the remaining ingredients are added at any of step a), b) or c): or in parts at any combination of said steps.

Preferably the water-phase is prepared by adding the salt and other water-soluble ingredients to the water. The water-phase may be subject to heating and/or mixing to suitably dissolve and homogenize the water-phase ingredients. Preferably the oil-phase is prepared by adding the oil-soluble ingredients to the liquid oil. The oil-phase may be subject to heating and/or mixing to suitably dissolve and homogenize the oil-phase ingredients. The water-in-oil promoting emulsifier may be added to either the water-phase or the oil-phase, but preferably to the oil-phase. There is a preference to dissolve the hard stock fat in the oil phase, optionally by warming the oil phase prior to mixing with the aqueous phase or the other oil-phase ingredients. Alternatively, a slurry is prepared by mixing a molten hardstock with an oil of lower temperature.

### The Pourable Product

The pourable product of the disclosure may contain one or more colouring agents. These are preferably added in a form of a concentrated additive, wherein said additive preferably has a concentration of at least 1 wt. %, more preferably of at least 10 wt. % and even more preferably of at least 20 wt. % of colouring agent, based on the total weight of the additive. For example in case the colouring agent is beta-carotene, said additive preferably has a concentration of at least 10 wt. % of beta-carotene based on the total weight of the additive (e.g. a 10 wt. % concentration of beta-carotene in vegetable oil). The one or more colouring agents can be added to the water-phase and/or the oil-phase, preferably as in accordance with their solubility. For example, beta-carotene is oil-soluble and therefore preferably is added to the oil-phase in the manufacture process.

Subsequently the preferably prepared pre-mix(es) may be added to the water-phase and/or the oil-phase preferably under sufficient shear. The temperature of the water-phase and/or oil-phase is preferably below the crystallization point of the hard stock fat as to allow crystallization under shear, which improves dispersion of the hard stock fat.

Finally the water-phase and oil-phase are combined, typically by mixing in a high shear mixer to provide the water-in-oil emulsion according to the disclosure. The mixing may be performed batch wise or in a continuous manner. Suitable mixing devices are known in the art, such as steered vessels equipped with an Ultra-turrax, pin-stirrer and fluid dynamic mixers. The mixing in step c) is preferably performed to provide an edible pourable water-in-oil emulsion wherein the dispersed water-phase droplets have an average size (as measured in D_{3,3}) of at most 10 micrometer, more preferably of at most 9, even more preferably of at most 8.

The D_{3,3} of the water-phase droplets can be measured as described herein elsewhere.

The average size of the water-phase droplets can for example be affected by applying sufficient time and/or mixing intensity during the mixing step c).

Some lower limit to the viscosity of the water-in-oil emulsion according to the disclosure is desirable to have more controlled pouring of the composition when desiring to apply a certain amount e.g. to a frying pan. As the water-in-oil emulsion is typically poured at temperature of about 5 degrees Celsius (e.g. when freshly taken from cold storage in a fridge) the viscosity of the pourable water-in-oil emulsion according to the disclosure as measured at 5 degrees Celsius is considered relevant. It was surprisingly found that the use of the hard stock fat according to the disclosure also leads to an increase in the viscosity of the pourable water-in-oil emulsion. Preferably the viscosity of the pourable water-in-oil emulsion according to the disclosure, as measured at 5 degrees Celsius and in accordance with the Brookfield measuring technique as described herein, is from 1000 to 2500 mPas, preferably from 1400 to 2200 mPas and even more preferably from 1600 to 2000 mPas.

The pourable fat containing products according to the disclosure have a Bostwick value of at least 12 at 20 degrees Celsius and preferably at least 15, more preferably at least 18.

### ABBREVIATIONS & SOURCES

| Abbreviation | Full or commercial name | Supplier |
|---|---|---|
| RPhe 70 | Fully hydrogenated High | ADM |
| | erucic acid Rapeseed | |
| RP | Rapeseed oil | Mosselman oleochemicals |
| Sunlec M | Sunflower lecithin | Sime Darby Oils Zwijndrecht, |
| | | the Netherlands |
| Cetinol | Lecithin, Bolec F | Sime Darby Oils Zwijndrecht, |
| | | the Netherlands |
| Beta | | BASF |
| Carotene 1% | | |

### Characterization of the Starting Component and the Reaction Products

The products resulting from the interesterification were analysed using the following analytical methods:

### FA Analysis

For any starting fat or product, the overall fatty acid analysis and the triglyceride composition is determined using conventional procedures in the art such as FAME analysis, GLC/Carbon number method and HPLC silver phase method such as described for example in EP78568, EP652289, JOACS (19914), 68 (5), 289-293 and Hammond E. W. J., Chromatography, 203, 397, 1981.

### Solid Fat Content (SFC) Measurements

The solid fat content (SFC) in this description and claims is expressed as N-value, as defined in Fette, Seifen Anstrichmittel 80 180-186 (1978). The stabilization profile applied is heating to a temperature of 80 degrees Celsius, keeping the oil for at least 10 minutes at 60 degrees Celsius or higher, keeping the oil for 1 hour at 0 degrees Celsius and then 30 minutes at the measuring temperature (tempered). An alternative method is described in IUPAC 2.150 method, serial, non-tempered.

### 2-Position Analysis

The method is based on the Joint JOCS/AOCS Official Method Ch 3a-19 (2019). This method provides a procedure for the determination of the composition of fatty acids which are esterified at the sn-2 position (B (beta) or internal position) of the triacylglycerol molecules in animal and vegetable fats and oils. The method is comprised of the 1 (3)-position selective transesterification of the triacylglycerols with ethanol by Candida antarctica lipase to yield 2-monoacylglycerols, followed by the separation of the 2-monoacylglycerols by silica-gel chromatography, and determination of their fatty acid composition by gas chromatography.

### Chemical Interesterification Procedure (CIE)

A blend is made between oils and fats in an appropriate ratio as specified to come to the desired hard stock fat. A stoichiometric amount of NaOH (50% w/w solution in water) is added to ensure FFA of the blend is <0.05% before catalyst dosing. Once the oil is free of FFA, the oil is dried under vacuum to eliminate any residual water (<100 ppm as measured by Karl Fisher titration). The catalyst is added (0.1% w/w sodium methoxide) and the blend brought under vacuum (25 mbar). The reaction starts when the color of the blend darkens (red/brownish). Once the reaction is started, the reaction is continued for 30 minutes at 90° C. and 25 mbar. After completion of the reaction, the catalyst is inactivated by breaking the vacuum in the reactor and adding citric acid. The acid is dosed to ensure 20% molar excess vis-a-vis added catalyst. Citric acid is dosed as a 20% solution (w/w in water). The mixture is allowed to react for 15 minutes at 90° C. at atmospheric pressure. The CIE hard stock fat is post-treated: bleached and deodorized. The resulting hard stock fat is analysed for TAG profile, N-line, 2-position FA analysis.

### Bleaching

The oil is heated to 85° C. A stoichiometric amount of citric acid (30% solution) is dosed to acidulate soaps and the mixture reacted for 15 minutes at atmospheric pressure. The oil is heated to 100° C. under vacuum (50 mbar). Bleaching earth (1%-Tonsil 210FF or equivalent activated clay) is added. The slurry is agitated for 30 minutes, at 100° C. and 50 mbar. The bleaching earth is filtered off.

### Deodorization

The bleached oil is deodorized until FFA<0.05% (indicative parameters: 240° C.—3 mbar—0.5-1% stripping steam). Cool down to 80° C. followed by purging with nitrogen and storage of the hard stock fat in hermetically closed recipients.

### Emulsification

Fats and spreads are prepared by blending fats, oils and/or aqueous phases using conventional procedures such as described in handbooks like “Fats and Oils Handbook”, 1998, Michael Bockisch.

### Viscosity

The viscosity was determined with a Brookfield viscometer (Type: DV-II Pro; Supplier: Brookfield) suitable for making viscosity measurements of a 600 ml beaker, using a spindle-type 4. The spindle was attached to the lower shaft of the viscometer. Next the spindle was lowered in the emulsion until the fluid level reached the immersion groove on the shaft of the spindle. The viscosity was measured of the emulsion having a temperature of 5 degrees Celsius with the viscometer operating at 100 rpm.

For a pourable emulsion the viscosity is between certain upper and lower limits. For pourable emulsions this is rated as:

| Viscosity | | | |
|---|---|---|---|
| rating (mPas) | Lower | Upper | |
| A | 1600 | 2000 | Good |
| B | 1500-1600 | 2000-2100 | moderate |
| C | <1500 | >2100 | Too thin or too thick |

For a pourable full fat product the viscosity is between certain upper and lower limits. For a full fat product this is rated as:

| Viscosity | | | |
|---|---|---|---|
| rating (mPas) | Lower | Upper | |
| A | 700 | 1200 | Good |
| B | 500-700 | 1200-1700 | moderate |
| C | <500 | >1700 | Too thin or too thick |

### Pourability

Pourability is measured according to the standard Bostwick protocol which is provided with the equipment. The Bostwick equipment consists of a 125 ml reservoir provided with an outlet near the bottom of a horizontally placed rectangular tub and closed with a vertical barrier. The tub's bottom is provided with a 25 cm measuring scale, extending from the outlet of the reservoir. When equipment and sample both have a temperature of 15 C, the reservoir is filled with 125 ml of the sample after it has been shaken by hand ten times up and down. When the closure of the reservoir is removed the sample flows from the reservoir and spreads over the tub bottom. The path length of the flow is measured after 15 seconds. The value, expressed as cm per 15 seconds is the Bostwick rating, which is used as yard stick for pourability (see table).

POURABILITY CATEGORIES FOR LIQUID MARGARINE

| Qualification | Bostwick value |
|---|---|
| Very thick | <1 |
| Thick | 1-5 |
| Squeezeable | 5-15 |
| Pourable | >15 |

### Water-Phase Droplet Size

The D_{3,3} of the water-phase droplets can be measured according to the following procedure: The normal terminology for Nuclear Magnetic Resonance (NMR) is used throughout this method. On the basis of this method the parameters D_{3,3} and exp(o) of a lognormal water droplet size distribution can be determined. The D_{3,3} is the volume weighted mean droplet diameter and σ (i.e. e<A>sigma) is the standard deviation of the logarithm of the droplet diameter. The NMR signal (echo height) of the protons of the water in a water-in-oil emulsion are measured using a sequence of 4 radio frequency pulses in the presence (echo height E) and absence (echo height E<*>) of two magnetic field gradient pulses as a function of the gradient power. The oil protons are suppressed in the first part of the sequence by a relaxation filter. The ratio (R=E/E<*>) reflects the extent of restriction of the translational mobility of the water molecules in the water droplets and thereby is a measure of the water droplet size. By a mathematical procedure, which uses the log-normal droplet size distribution, the parameters of the water droplet size distribution D_{3,3} (volume weighed geometric mean diameter) and σ (distribution width) are calculated. A Bruker magnet with a field of 0.47 Tesla (20 MHz proton frequency) with an air gap of 25 mm is used (NMR Spectrometer Bruker Minispec MQ20 Grad, ex Bruker Optik GmbH, DE).

Droplet size for pourable emulsions is classified as:

| Droplet size | D_{3, 3} |
|---|---|
| A | <8 |
| B | 8-9 |
| C | >9 |

### Stability

Stability is measured by determining the relative amount of exudation. Exudation (separation of oil from the emulsion is measured as the height of visible free oil in % of the height of the product. A stoppered all glass measuring cylinder of 100 ml or a stoppered bottle is filled up with the sample to the top mark. After two weeks storage at 15 degrees Celsius the thickness of the separated oil layer is measured and expressed as % on the total sample height. The % is the rating for emulsion stability.

Stability for pourable emulsions is classified as:

| Stability | Exudation % |
|---|---|
| A | <3 |
| B | 3-4 |
| C | >4 |

### Determination of Foaming

A sample of 25 g of product is place in a glass dish, which is heated using an electrical plate to about 165 degrees Celsius. Any foam formation (and the disappearance thereof) is observed and noted by eye during initial heating of the cooking product. After disappearance of the foam (if any formed during heating of the product) the emulsion is left for another 5 minutes at 165 degrees Celsius. Next 10 ml of cold water is added to the dish (to simulate addition of a water-containing food product) and foam formation in terms of amount and maintenance in time noted. Foam amount is then indicated by the maximum observed foam coverage (in % of the dish-surface), which value can range from 0% to 100%.

### EXAMPLES

### Hard Stock Fat: 1 High Stearic Acid Fat (GTS)

A hard stock fat was obtained by reacting stearic acid with glycerol under increased pressure and temperature in a conventional way (24 hrs, 150-220 degrees Celsius, reduced pressure). After completion of the reaction, the free fatty acids were removed by stripping to yield a fat with a C18:0 content of 96.4%. The fat is obtained using conventional work-up processes such as bleaching and deodorisation. Available data of the hard stock fat are presented in Table 1.

### Hard Stock Fat 2 High Behenic Acid Fat (GTB)

A hard stock fat was obtained by reacting behenic acid with glycerol under increased pressure and temperature in a conventional way (24 hrs, 150-220 degrees Celsius, reduced pressure). After completion of the reaction, the free fatty acids were removed by stripping to yield a fat with a C22:0 content of 98%. The fat is obtained using conventional work-up processes such as bleaching and deodorisation. Available data of the hard stock fat are presented in Table 1.

### Hard Stock Fat 3: High Stearic and Behenic Acid Fat GBS, 35% B, 65% S

A hard stock fat was obtained by reacting a mixture of 65 wt. % stearic acid and 35 wt. % behenic acid with glycerol under increased pressure and temperature in a conventional way (24 hrs, 150-220 degrees Celsius, reduced pressure) to completion. Free fatty acids were removed by stripping to yield a fat with a C18:0 content of 64 wt. % and a C22:0 content of 35 wt. % The fat is obtained using conventional work-up processes such as bleaching and deodorisation. Available data of the hard stock fat are presented in Table 1.

### Hard Stock Fat 4: Blend of 75% High Stearic Fat GTS and 25% High Behenic Acid Fat GTB

A fat was obtained by blending of 75 wt. % hard stock 1 (GTS) and 25 wt. % hard stock 2 (GTB). Available data of the hard stock fat are presented in Table 1.

Hard Stock Fat 5: Interesterified Blend of 75% High Stearic Fat GTS and 25% High Behenic Acid Fat GTB (ie (75GTS/25GTB))

A fat was obtained by the interesterification of a blend of 75 wt. % hard stock 1 (GTS) and 25 wt. % hard stock 2 (GTB). The fat is obtained using conventional work-up processes such as bleaching and deodorisation. Available data of the hard stock fat are presented in Table 1.

Hard Stock Fat 6: High Stearic and Behenic Acid Fat, 20% B, 80% S (gGBS(80S/20B))

A hard stock fat was obtained by reacting a mixture of 80 wt. % stearic acid and 20 wt. % behenic acid with glycerol under increased pressure and temperature in a conventional way to completion. Free fatty acids were removed by stripping to yield a fat with a C22:0 content of 19.7 wt. %. The fat is obtained using conventional work-up processes such as bleaching and deodorisation. Available data of the hard stock fat are presented in Table 1.

### Emulsions

Pourable edible emulsions were made with the general composition as depicted in Table 2

TABLE 2

| Fat phase wt. % | |
|---|---|
| Oil (rapeseed (RP)) | Variable |
| RPhe 70 | Variable |
| Hard stock fat (33% in RP) | Variable |
| Sunlec M | 0.2 |
| Cetinol | 0.1 |
| Beta Carotene 1% | 0.1 |
| Fat phase Total | 78.0 |
| Salt | 1.5 |
| Citric acid | 0.1 |
| Water | 20.5 |
| Aqueous phase total | 22.0 |
| Total | 100.0 |

The fat phase used oil and a hard stock. When the hard stock amount was varied, the fat phase was supplemented with oil up to the desired level (78 wt. %, calculated on the total product). As a comparative example and market standard RPhE70 was used as hard stock fat, fully hydrogenated high erucic acid rape seed oil. Various alternative hard stock fats were tested: GTS, GTB, GBS, blends of GTS with GTB and GBS and in varying amounts. The hard stock fats of the disclosure are supplied as 33% w/w solution in oil. The composition of the hard stock fats was as in Table 3.

TABLE 3

| Example | Hard stock fat* |
|---|---|
| Comparative Example 1 | 1.95% RPhe70 |
| Comparative Example 2 | 1.5% GTS** |
| Comparative Example 3 | 1.95% GTS** |
| Comparative Example 4 | 2.5% GTS** |
| Comparative Example 5 | 3% GTS** |
| Comparative Example 6 | 4% GTS** |
| Example 1 | 1.95% GBS** |
| Example 2 | 1.95% 75GTS/25GTB** |
| Example 3 | 1.50% GBS** |
| Example 4 | 1.00% GBS** |
| Example 5 | 1.95% GTB** |
| Example 6 | 1.00 GTB** |

*wt. % on total product;
**hard stock supplied as 33% solution in oil.

Resulting emulsions were subjected to various temperature cycling experiments to test the behavior of the emulsion over time. In temperature cycling experiments the emulsion is stored for a period after production following by an emulation of conventional conditions simulating transport, storage and use.

The following protocols were used:

Storage stability:
5° C. for 17 weeks
20° C. for 17 weeks
5° C. for 7 weeks
20° C. for 6 weeks

Cycling stability: the product is stabilized for a set number of days at a temperature after which the temperature is varied per day over a period of 7 days. B2 and C3 cycles are preceded by B or C cycle, respectively (Table 4).

TABLE 4

| | Stabilization | Simulation (day) | | | | | | |
|---|---|---|---|---|---|---|---|---|
| Module | 14 days | 1 | 1 | 1 | 1 | 1 | 1 | 1 |
| B (° C.) | 15 | 25 | 25 | 15 | 15 | 15 | 15 | 10 |
| B2 (° C.) | 5 | 25 | 5 | 25 | 5 | 25 | 5 | 10 |
| C (° C.) | 15 | 30 | 30 | 15 | 15 | 15 | 15 | 10 |
| C3 (° C.) | 15 | 30 | 10 | 30 | 10 | 30 | 10 | 10 |
| D (° C.) | 30 | 35 | 35 | 25 | 25 | 25 | 25 | 10 |
| D3 (° C.) | 15 | 30 | 10 | 30 | 10 | 30 | 10 | 10 |

The experiments revealed that 1.95 wt. % GBS provides similar stability and viscosity as the conventional RPhe70 and is a good replacement. It was also found that using GBS the amount of hard stock fat can be further reduced, as 1% wt. % GBS (example 4) still gives an acceptable stability and viscosity. That is effectively a 50% reduction in the use of hard stock fat. The results of the tests are in Table 5

TABLE 5

| | | | 5° C. for 17 weeks | | | 20° C. for 17 weeks | | | B-cycle | | | C-cycle | | |
|---|---|---|---|---|---|---|---|---|---|---|---|---|---|---|
| C. | hard stock | | | D₃₃/ | | | D₃₃/ | | | D₃₃/ | | | D₃₃/ | |
| Ex. | fat | % | stability | e^{sigma} | viscosity | stability | e^{sigma} | viscosity | stability | e^{sigma} | viscosity | stability | e^{sigma} | viscosity |
| 1 | RPhe70 | 1.95 | A | A | A | A | A | A | A | A | A | | | |
| 2 | GTS | 1.50 | A | C | A | C | C | C | C | C | C | | | |
| 3 | GTS | 1.95 | A | C | B | C | C | B | C | C | C | | | |
| 4 | GTS | 2.50 | A | B | A | C | C | A | C | C | A | | | |
| 5 | GTS | 3 | A | A | C | A | B | B | A | C | B | | | |
| 6 | GTS | 4 | A | A | C | A | A | C | A | A | C | | | |

| Ex. | | | 5° C. for 7 weeks | | | 20° C. for 6 weeks | | | B-cycle | | | C-cycle | | |
|---|---|---|---|---|---|---|---|---|---|---|---|---|---|---|
| 1 | GBS | 1.95 | A | A | A | A | A | A | A*** | A | A | A | A | A |
| 2 | 75GTS/ | 1.95 | A | A | B*** | A | A | A | A | A | A | A | A | A |
| | 25GTB | | | | | | | | | | | | | |
| 3 | GBS | 1.5 | A | A | A | A | A | A | A* | A | A | A** | A | A |
| 4 | GBS | 1 | A | A | A | B | A | A | B | A | A | A | A | A |
| 5 | GTB | 1.95 | A | A | C*** | B | A | A | B | A | A | A**** | A**** | A**** |
| 6 | GTB | 1 | A | A | C | A*** | A | C | A | A | A | A | A | A |

*Also B2-cycle stable
**Also C3-cycle stable
***reduced pourabulity, too thick
****D-cycle + D 3 Cycle
****Very thick

| | B2 cycle | | C3 cycle | | 5 degrees | | | 20 degrees | | | 25 degrees | | |
|---|---|---|---|---|---|---|---|---|---|---|---|---|---|
| | Stab*. | D₃₃/ | Stab*. | D₃₃/ | | D₃₃/ | Stab*. | D₃₃/ | Stab*. | | D₃₃/ | Stab*. | |
| Ex. | (mm) | e^{sigma} | (mm) | e^{sigma} | Viscosity | e^{sigma} | (mm) | e^{sigma} | (mm) | Viscosity | e^{sigma} | (mm) | Viscosity |
| GBS | 0 | 7.6/1.8 | 1 | 8.0/1.8 | 2551 | 5.2/1.8 | 0 | 6.9/1.7 | 0 | 1414 | 6.9/1.7 | 2 | 1300 |
| 1.95% | | | | | | | | | | | | | |
| RPhe70 | 1 | 12.2/1.9 | 1 | 13.3/1.9 | 1944 | 5.5/1.7 | 0 | 10.0/1.8 | 0 | 970 | 10.3/0.8 | 0 | 1010 |
| 1.95% | | | | | | | | | | | | | |

*Stability

### Full Fat Products

Full fat products were made with the general composition as depicted in Table 6.

TABLE 6

| Fat phase wt. % | |
|---|---|
| Oil (rapeseed (RP)) | Variable |
| RPhe70 | Variable |
| Hard stock fat (33% in RP) | Variable |
| Bolec Z | 0.4 |
| Beta Carotene 30% | 0.0014 |
| Salt + aroma | 2.3 |
| Total | 100 |

The fat phase used oil and a hard stock. When the hard stock amount was varied, the fat phase was supplemented with oil up to the desired level (up to 98.5 wt. %, calculated on the total product).

As a comparative example and market standard RPhE70 was used as hard stock fat, fully hydrogenated high erucic acid rape seed oil. Various alternative hard stock fats were tested: GTS, GTB, GBS, blends of GTS with GTB and GBS and in varying amounts.

The composition of the hard stock fats in the full fat products was as in Table 7.

TABLE 7

| Example | Hard stock fat* |
|---|---|
| Comparative Example 7 | 1.95% RPhe70 |
| Example 7 | 1.55% Hard Stock 6 |
| Example 8 | 1.75% Hard Stock 6 |

*wt. % on total product;

Resulting full fat products were subjected to various temperature cycling experiments to test the behavior of the full fat product over time. In temperature cycling experiments the full fat product is stored for a period after production following by an emulation of conventional conditions simulating transport, storage and use.

The results of the tests are in Table 8:

TABLE 8

| | Period | T | | Comparative | | |
|---|---|---|---|---|---|---|
| | (wk) | (° C.) | unit | Example 7 | Example 7 | Example 8 |
| Viscosity | 1 | 5 | cP | 1000 | 1172 | 1172 |
| | 8 | 5 | cP | 1014 | 1214 | 1134 |
| | 1 | 20 | cP | 1150 | 760 | 790 |
| | 8 | 20 | cP | 1146 | 794 | 798 |
| | 1 | 25 | cP | 1085 | 606 | 648 |
| | 8 | 25 | cP | 1092 | 578 | 654 |
| Oil | 1 | 5 | % | 0 | 0 | 0 |
| Exudation | 8 | 5 | % | 0 | 0 | 0 |

Hard Stock 6 leads to an improved viscosity with an acceptable stability while being used in a lower (more economical and less SAFA) amount.

TABLE 1
Parameters of source materials and products

| | Parameters | | | | | | | |
|---|---|---|---|---|---|---|---|---|
| | | | GT5 | GTB | gGBS (65S/35B) | Blend 75GTS/25GTB | ie(75GTS/25GTB) | gGBS(80S/20B) |
| Example | RP | heRP70 | HS 1 | HS2 | HS3 | HS4 | HS5 | HS6 |
| Fat phase | | | | | | | | |
| Hard stock wt. % | | 100 | 100 | 100 | 100 | 100 | 100 | 100 |
| heRP70 | | 100 | | | | | | |
| GTS | | | 100 | | | 75 | 75 | |
| GTB | | | | 100 | | 25 | 25 | |
| FAC [%] | | | | | | | | 100 |
| C16:0 (P) | 4.7 | 3.9 | 2.6 | 0.5 | 2.9 | 2.1 | 2.1 | 1.4 |
| C18:0 (S) | 1.6 | 41.3 | 91.0 | 0.5 | 67.4 | 68.4 | 68.4 | 78.6 |
| C18:1 | 60.4 | 0.5 | 3.0 | | 0.2 | 2.3 | 2.3 | 0.1 |
| C18:2 | 20.0 | | 0.7 | | 0.1 | 0.5 | 0.5 | 0.1 |
| C18:3 | 9.2 | | 0.1 | | | | | |
| C20:0 (A) | 0.8 | 8.1 | | 1.0 | 3.1 | 0.3 | 0.3 | |
| C22:0 (B) | 0.3 | 45.0 | 0.5 | 98.0 | 25.7 | 24.9 | 24.9 | 19.7 |
| SAFA | 7.4 | 98.3 | 95.1 | 98.3 | 99.1 | 95.6 | 95.6 | 98.3 |
| MUFA | 62.8 | 0.5 | 3.0 | 0.1 | 0.2 | 2.3 | 2.3 | 1.5 |
| PUFA | 29.2 | 0.0 | 0.8 | 0.0 | 0.1 | 0.5 | 0.5 | 0.1 |
| C18:0 on Hard stock | | 41 | 92 | 0 | 68 | 69 | 69 | 79 |
| C22:0 on Hard stock | | 45 | 1 | 100 | 26 | 25 | 25 | 20 |
| C18:0 + C22:0 on Hard stock | | 86 | 93 | 100 | 94 | 94 | 94 | 99 |
| 2-position | | | | | | | | |
| C16:0 | | 2.0 | 2.5 | 0.5 | 2.7 | 2.0 | 2.1 | 0.1 |
| C18:0 | | 96.1 | 97.5 | 0.0 | 63.9 | 73.3 | 72.3 | 79.0 |
| C22:0 | | 1.0 | 0 | 99.0 | 24.4 | 24.8 | 25.3 | 19.6 |
| Carbon Number | | | | | | | | |
| SSS (CN54) | 12.6 | 12.4 | 75 | | 37.2 | 56.3 | 28.6 | |
| PSB/SSA (CN56) | 84.7 | 8.7 | 4.8 | | 7.9 | 3.6 | 12.7 | |
| SSB (CN58) | 1.6 | 8.8 | 1.8 | | 34.8 | 1.4 | 30.2 | |
| PBB (C60) | | 16.4 | | | 3.7 | 0.1 | 6.8 | |
| SBB (CN62) | | 47.8 | | | 9.8 | 0.1 | 10.7 | |
| BBB (CN60) | | 0.2 | | 98.0 | 0.4 | 24.5 | 1.3 | |

| | | | | | | | | 1.95 | | | | | | |
|---|---|---|---|---|---|---|---|---|---|---|---|---|---|---|
| | | | | | | | | gGBS | | | | | | |
| | | | | | | | | (75GTS/ | 1.5 | 1 | 1.95 | 1 | 1.55 | 1.75 |
| | 1.95 | 1.5 | 1.95 | 2.5 | 3 | 4 | 1.95 | 25GTB)/ | GBS/ | GBS/ | GTB/ | GTB/ | HS6 | HS6/ |
| | heRP70 | GTS | GTS | GTS | GTS | GTS | GBS | 76RP | 76.RP | 76.5RP | 76RP | 76RP | 98.45RP | 98.25RP |
| Example | C Ex 1 | C Ex 2 | C Ex 3 | C Ex 4 | C Ex 5 | C Ex 6 | Ex 1 | Ex 2 | Ex 3 | Ex 4 | Ex 5 | Ex 6 | Ex 7 | Ex 8 |
| Fat phase | | | | | | | | | | | | | | |
| Oil wt. % | 76 | 76.5 | 76 | 75.5 | 75 | 74 | 76 | 76 | 76.5 | 77 | 76 | 77 | 98.45 | 98.25 |
| Hard | 1.95 | 1.5 | 1.95 | 2.5 | 3 | 4 | 1.95 | 1.95 | 1.5 | 1 | 1.95 | 1 | 1.55 | 1.75 |
| stock | | | | | | | | | | | | | | |
| wt. % | | | | | | | | | | | | | | |
| FAC [%] | | | | | | | | | | | | | | |
| C16:0 (P) | 4.6 | 4.6 | 4.6 | 4.6 | 4.6 | 4.6 | 4.6 | 4.6 | 4.6 | 4.6 | 4.6 | 4.6 | 4.6 | 4.6 |
| C18:0 (S) | 2.6 | 3.3 | 3.8 | 4.5 | 5.0 | 6.2 | 1.5 | 3.1 | 2.8 | 2.4 | 1.5 | 1.5 | 2.8 | 2.8 |
| C18:1 | 58.9 | 59.4 | 59.0 | 58.6 | 58.2 | 57.4 | 58.9 | 58.9 | 59.2 | 59.6 | 58.9 | 59.6 | 59.3 | 59.3 |
| C18:2 | 19.5 | 19.6 | 19.5 | 19.4 | 19.2 | 19.0 | 19.5 | 19.5 | 19.6 | 19.7 | 19.5 | 19.7 | 19.7 | 19.7 |
| C18:3 | 9.0 | 9.0 | 9.0 | 8.8 | 8.8 | 8.7 | 9.0 | 9.0 | 9.0 | 9.1 | 9.0 | 9.1 | 9.0 | 9.0 |
| C20:0 (A) | 1.0 | 0.8 | 0.8 | 0.8 | 0.8 | 0.8 | 0.8 | 0.8 | 0.9 | 0.8 | 0.8 | 0.8 | 0.8 | 0.8 |
| C20:1 | 1.9 | 1.9 | 1.9 | 1.9 | 1.9 | 1.9 | 1.9 | 1.9 | 19 | 1.9 | 1.9 | 1.9 | 0.6 | 0.6 |
| C22:0 (B) | 1.4 | 0.3 | 0.3 | 0.3 | 0.3 | 0.3 | 0.3 | 1.2 | 0.8 | 0.6 | 2.7 | 1.5 | 0.6 | 0.6 |
| C22:1 | 0.4 | 0.4 | 0.4 | 0.4 | 0.4 | 0.4 | 0.4 | 0.4 | 0.4 | 0.4 | 0.4 | 0.4 | | |
| SFA | 9.6 | 9.0 | 9.5 | 10.1 | 10.6 | 11.8 | 7.2 | 9.6 | 9.1 | 8.5 | 9.6 | 8.5 | 8.8 | 8.8 |
| MUFA | 58.9 | 59.4 | 59.0 | 58.6 | 58.2 | 57.4 | 58.9 | 58.9 | 59.2 | 59.6 | 58.9 | 59.6 | 59.3 | 59.3 |
| PUFA | 28.5 | 28.6 | 28.5 | 28.2 | 28.1 | 27.7 | 28.5 | 28.5 | 28.6 | 28.8 | 28.5 | 28.8 | 28.7 | 28.7 |
| C18:0 on | 3% | 3% | 4% | 4% | 5% | 6% | 2% | 3% | 3% | 2% | 2% | 2% | | |
| Product | | | | | | | | | | | | | | |
| C22:0 on | 1% | 0% | 0% | 0% | 0% | 0% | 0% | 1% | 1% | 1% | 3% | 2% | | |
| Product | | | | | | | | | | | | | | |
| C18:0 + C2 | 4% | 4% | 4% | 5% | 5% | 7% | 2% | 4% | 4% | 3% | 4% | 3% | | |
| 2:0 on | | | | | | | | | | | | | | |
| Product | | | | | | | | | | | | | | |

### EMBODIMENTS

1. Edible, pourable, fat-containing product, in the form of a water-in-oil emulsion or a full fat product, comprising:
   40 to 99.9 wt. % liquid vegetable oil;
   0.1 to 10 wt. % of hard stock fat:
wt. % calculated on the total weight of the product,
   wherein the hard stock fat is
      i. free from palm or palm-derived fats or fat fractions:
      ii. free from hydrogenated fats or fat fractions:
      iii. has a C22:0 (behenic acid) content of at least 10 wt. %, wt. % calculated on the total amount of fatty acids in the hard stock.
2. Edible, pourable fat-containing product according to the previous embodiment, wherein the product further comprises water, preferably up to 100 wt. %.
3. Edible, pourable, fat-containing product according to any of the previous embodiments, wherein the hard stock fat comprises at least 15 wt. % behenic acid.
4. Edible, pourable, fat-containing product according to any of the previous embodiments, wherein the hard stock fat is present in an amount of from 0.01 to 10, 0.1 to 8, 0.2 to 6, 0.5 to 3 wt. %, wt. % calculated on the total amount of fat in the product.
5. Edible, pourable, fat-containing product according to any of the previous embodiments, wherein the hard stock fat is present an amount of less than 2, 1.99, 1.98, 1.95, 1.90, 1.80, 1.75, 1.5, 1.2 wt. %, wt. % calculated on the total amount of product.
6. Edible, pourable, fat-containing product according to any of the previous embodiments, wherein the hard stock fat has a behenic acid content (C22:0) of at least 10, 15, 20, 25, 30, 35, 40, 45, 50 wt. %, wt. % calculated on the total amount of fatty acids in the hard stock fat.
7. Edible, pourable, fat-containing product according to any of the previous embodiments, wherein the hard stock fat comprise behenic acid residues (C22:0) in an amount of at most 50, 45, 40, 35, 30, 25, 20, 15, 10 wt. %, wt. % calculated on the total amount of fatty acids in the hard stock fat.
8. Edible, pourable, fat-containing product according to any of the previous embodiments, wherein the hard stock fat comprises behenic acid fatty residues between 12 and 50, 17 and 45, 22 and 40 wt. %, wt. % calculated on the total amount of fatty acids in the hard stock fat.
9. Edible, pourable, fat-containing product according to any of the previous embodiments, wherein hard stock fat is a single fat or a mixture of different fats (a blend).
10. Edible, pourable, fat-containing product according to any of the previous embodiments, wherein the hard stock fat is obtained via interesterification of two or more fats.
11. Edible, pourable, fat-containing product according to any of the previous embodiments, wherein the hard stock fat is made from fats of vegetable origin.
12. Edible, pourable, fat-containing product according to any of the previous embodiments, wherein the hard stock fat does not contain, not more than 5 wt. %, 4 wt. %, 3 wt. %, 2 wt. % palm-oil derived fat or fractions thereof, wt. % calculated on the total amount of fatty acids in the hard stock fat.
13. Edible, pourable, fat-containing product according to any of the previous embodiments, wherein the hard stock fat does not contain, not more than 5 wt. %, 4 wt. %, 3 wt. %, 2 wt. % hydrogenated fat, wt. % calculated on the total amount of fatty acids in the hard stock fat.
14. Edible, pourable, fat-containing product according to any of the previous embodiments, wherein the hard stock fat comprises stearic acid residues (C18:0, S) in an amount of at most 85, 80, 75, 70, 65, 60, 50, 40 wt. %, wt. % calculated on the total amount of fatty acids in the hard stock fat.
15. Edible, pourable, fat-containing product according to any of the previous embodiments, wherein the hard stock fat contains a blend of a first fat that contains at least 40, 50, 60, 70, 80, 90 wt. % stearic acid, wt. % calculated on the total amount of fatty acids in the first fat, with a second or further fat.
16. Edible, pourable, fat-containing product according to any of the previous embodiments, wherein in the hard stock fat, the second fat or further contains at least 40, 50, 60, 70, 80, 90 wt. % behenic acid, wt. % calculated on the total amount of fatty acids in the second or further fat.
17. Edible, pourable, fat-containing product according to any of the previous embodiments, wherein in the hard stock fat, the sum of stearic acid residues (S, C18:0) and behenic acid residues (C22:0, B) is at least 60, 70, 80, 90, 95 wt. %, wt. % calculated on the total amount of fatty acids in the hard stock fat.
18. Edible, pourable, fat-containing product according to any of the previous embodiments, wherein the hard stock fat substantially consists of (i.e. contain up to 100 wt. %), comprise up to 99, 98, 97, 96, 95, 90 wt. % of stearic acid residues and/or behenic acid residues, wt. % calculated on the total amount of fatty acids in the hard stock fat.
19. Edible, pourable fat-containing product according to any of the previous embodiments, wherein the hard stock fat comprises less than 45, 40, 35, 30, 25 wt. % of triglycerides of the SBB type (CN62), wt. % calculated on the total amount of triglycerides in the hard stock.
20. Edible, pourable fat-containing product according to any of the previous embodiments, wherein the hard stock fat comprises more than 45, 40, 35, 30, 25, 20, 15, 10 wt. % of triglycerides of the SSB type (CN58), wt. % calculated on the total amount of triglycerides in the hard stock.
21. Edible, pourable fat-containing product according to any of the previous embodiments, wherein the hard stock fat contains SBB (CN62) and SSB (CN58) (SBB+SSB) in an amount between 20 and 65, 25 and 60, 30 and 55, 35 and 50 wt. %, wt. % calculated on the total amount of triglycerides in the hard stock.
22. Edible, pourable fat-containing product according to any of the previous embodiments, wherein the hard stock fat contains less than 50, 45, 40, 35, 30, 25, 20, 15 wt. %, of SSS (glyceroltristearate), wt. % calculated on the total amount of triglycerides in the hard stock.
23. Edible, pourable fat-containing product according to any of the previous embodiments, wherein the hard stock fat contains C18:0 on the 2-position of the glycerol backbone in an amount of less than 75, 70, 65, 60, 55, 50, 45, 40 wt. %, wt. % calculated on the total amount of fatty acids on the 2-position of the glycerol backbone.
24. Edible, pourable fat-containing product according to any of the previous embodiments, wherein the hard stock fat contains C18:0 on the 2-position of the glycerol backbone in an amount of between 40 and 75, 45 and 70, 50 and 65 wt. %, wt. % calculated on the total amount of fatty acids on the 2-position of the glycerol backbone.
25. Edible, pourable fat-containing product according to any of the previous embodiments, wherein the hard stock fat contains C22:0 on the 2-position of the glycerol backbone in an amount of more than 10, 15, 20, 25, 30, 35, 40 wt. %, wt. % calculated on the total amount of fatty acids on the 2-position of the glycerol backbone.
26. Edible, pourable fat-containing product according to any of the previous embodiments, wherein the hard stock fat contains C22:0 on the 2-position of the glycerol backbone in an amount of between 15 and 40, 20 and 35 wt. %, 25 and 30 wt. % calculated on the total amount of fatty acids on the 2-position of the glycerol backbone.
27. Edible, pourable fat-containing product according to any of the previous embodiments, wherein the hard stock fat of the disclosure can be further characterised by one or more of
   2-C18:0 between 40 and 75 wt. %, wt. % calculated on the total amount of fatty acids on the 2-position of the glycerol backbone,
   2-C22:0 between 15 and 50 wt. %, wt. % calculated on the total amount of fatty acids on the 2-position of the glycerol backbone,
   SBB of below 45 wt. %, wt. % calculated on the total amount of triglycerides in the hard stock,
   SSB of more than 10 wt. %, wt. % calculated on the total amount of triglycerides in the hard stock
   PBB (CN60) of less than 15 wt. %, wt. % calculated on the total amount of triglycerides in the hard stock, preferably less than 12, 10, 8 wt. %.
   SSS of more than 15 wt. %, wt. % calculated on the total amount of triglycerides in the hard stock.
28. Edible, pourable fat-containing product according to any of the previous embodiments, wherein the hard stock fat comprises stearic acid fatty residues and behenic fatty acid residues in a ratio (stearic acid:behenic acid) of between 90:10 and 10:90, 80:20 and 20:80, 75:25 and 25:75, 65:35 and 80:20.
29. Edible, pourable fat-containing product according to any of the previous embodiments, wherein the hard stock fat contains stearic acid and behenic acid in a C18:0/C18:0+C22:0 ratio of between 0.50 and 0.85, 0.55 and 0.80, 0.60 and 0.75.
30. Edible, pourable fat-containing product according to any of the previous embodiments, wherein the hard stock fat contains stearic acid and behenic acid in a (C22:0/C18:0+C22:0) ratio of between 0.15 and 0.45, 0.20 and 0.40, 0.25 and 0.35.
31. Edible, pourable fat-containing product according to any of the previous embodiments, wherein the hard stock fat contains glyceroltristearate (GTS) or glyceroltribehenate (GTB) alone or in combination.
32. Edible, pourable fat-containing product according to any of the previous embodiments, wherein the hard stock fat contains GTS:GTB in a ratio of 80:20 to 20:80, 70:30 to 30:70, 60:40 to 40:60, 50:50.
33. Edible, pourable fat-containing product according to any of the previous embodiments, wherein in the hard stock the sum of C18:0 and C22:0 fatty acids is more than 50, 60, 70, 80, 90, 95 wt. %, wt. % calculated on the total amount of fatty acids in the hard stock.
34. Hard stock fat as defined in any of the previous embodiments that is free from palm or palm-derived fats or fat fractions, free from hydrogenated fats or fat fractions and has a C22:0 (behenic acid) content of at least 10, 15, 20 wt. %, wt. % calculated on the total amount of fatty acids in the hard stock.
35. Use of a fat free from hydrogenated and palm-derived triacylglycerides as defined in any of the previous embodiments as a hard stock fat, preferably in pourable fat-containing products.

1. Edible, pourable, fat-containing product comprising:
40 to 99.9 wt. % liquid vegetable oil;
0.1 to 10 wt. % of hard stock fat;
all wt. % calculated on the total weight of the product,
wherein the hard stock fat is
i. free from palm or palm-derived fats or fat fractions;
ii. free from hydrogenated fats or fat fractions; and
iii. has a C22:0 (behenic acid) content of at least 15 wt. %, wt. % calculated on the amount of fatty acids in the hard stock.

2. Edible, pourable fat-containing product according to claim 1, wherein the product is in the form of a water in oil emulsion or a full fat product.

3. Edible, pourable fat-containing product according to claim 1, wherein the product comprises 40 to 95 wt. % of liquid vegetable oil.

4. Edible, pourable fat-containing product according to claim 1, wherein the product comprises from 0.1 to 8 wt. % of hard stock fat.

5. Edible, pourable fat-containing product according to claim 1, wherein the hard stock fat has a C18:0 content of at most 85 wt. %, wt. % calculated on the amount of fatty acids in the hard stock fat.

6. Edible, pourable fat-containing product according to claim 1, wherein the hard stock comprises a blend of a first fat that contains at least 50 wt. % stearic acid with a second fat that contains at least 50 wt. % behenic acid, wt. % calculated on the total amount of fatty acids in the respective first and second fat.

7. Edible, pourable fat-containing product according to claim 5, wherein the blend is an interesterified blend.

8. Edible, pourable fat-containing product according to claim 1, wherein the hard stock fat comprises at most 85 wt. % stearic acid.

9. Edible, pourable fat-containing product according to claim 1, wherein in the hard stock the sum of C18:0 and C22:0 fatty acids is more than 50 wt. %, wt. % calculated on the total amount of fatty acids in the hard stock.

10. Edible, pourable fat-containing product according to claim 1, wherein the hard stock contains triglycerides of the SBB type (CN62) of less than 10 wt %, wt. % calculated on the total amount of triglycerides in the hard stock.

11. Edible, pourable fat-containing product according to claim 1, wherein the hard stock fat contains C18:0 on the 2-position of the glycerol backbone in an amount of less than 75 wt. %, wt. % calculated on the total amount of fatty acids on the 2-position of the glycerol backbone.

12. Edible, pourable fat-containing product according to claim 1, wherein the hard stock fat contains C22:0 on the 2-position of the glycerol backbone in an amount of more than 15 wt. %, wt. % calculated on the total amount of fatty acids on the 2-position of the glycerol backbone.

13. Process for the manufacturing of an edible pourable product according to claim 1, comprising the steps:
a) providing a water-phase;
b) providing a liquid oil;
c) providing a hard stock
d) mixing the liquid oil, the hard stock fat and the optional water-phase to provide the edible pourable product.

14. Edible, pourable fat-containing product according to claim 1, wherein the hard stock fat is used as structuring fat in the pourable fat-containing product.

15. Process for the manufacturing of an edible pourable product according to claim 14, wherein the hard stock fat is used in an amount of less than 2 wt. %, wt. % calculated on the total weight of the product.
